(19) United States
(12) Patent Application Publication
(10) Pub. No.: US 2007/0239305 A1
(43) Pub. Date: Oct. 11, 2007

(54) Process control systems and methods

(76) Inventors: Haoren Zhuang, Hopewell Junction, NY (US); Chandrasekhar Sarma, Poughkeepsie, NY (US); Matthias Lipinski, Poughkeepsie, NY (US); Jingyu Lian, Hopewell Junction, NY (US); Alois Gutmann, Poughkeepsie, NY (US)

Correspondence Address: SLATER & MATSIL LLP, 17950 PRESTON ROAD, SUITE 1000, DALLAS, TX, 75252, US

(21) Appl. No.: 11/390,696

(22) Filed: Mar. 28, 2006

(51) Int. Cl. G06F 19/00

(52) U.S. Cl. 700/108; 700/121

(57) ABSTRACT

Process control systems and methods for semiconductor device manufacturing are disclosed. A plurality of feedback and feed-forward loops are used to accurately control the critical dimension (CD) of features formed on material layers of semiconductor devices. Semiconductor devices with features having substantially the same dimension for each die across the surface of a wafer may be fabricated using the novel process control systems and methods described herein.

### TECHNICAL FIELD

The present invention relates generally to the fabrication of semiconductor devices, and more particularly to process control systems and methods for the fabrication of semiconductor devices.

### BACKGROUND

Generally, semiconductor devices are used in a variety of electronic applications, such as computers, cellular phones, personal computing devices, and many other applications. Semiconductor devices are manufactured by depositing many different types of material layers over a semiconductor workpiece or wafer, and patterning the various material layers using lithography. The material layers typically comprise thin films of conductive, semiconductive, and insulating materials that are patterned and etched to form integrated circuits (ICs). There may be a plurality of transistors, memory devices, switches, conductive lines, diodes, capacitors, logic circuits, and other electronic components formed on a single die or chip, for example.

Optical photolithography involves projecting or transmitting light through a pattern made of optically opaque or translucent areas and optically clear or transparent areas on a mask or reticle onto a layer of photosensitive material disposed over a wafer. For many years in the semiconductor industry, optical lithography techniques such as contact printing, proximity printing, and projection printing have been used to pattern material layers of integrated circuits. Lens projection systems and transmission lithography masks are used for patterning, wherein light is passed through the lithography mask to impinge upon a semiconductor wafer or workpiece.

There is a trend in the semiconductor industry towards scaling down the size of intergrated circuits, in order to meet the demands of increased performance and smaller device size. As features of semiconductor devices become smaller, it becomes more difficult to pattern the various material layers because of diffraction and other effects that occur during the lithography process.

In particular, lithography techniques used to pattern the various material layers become challenging as device features shrink. The position of the die on the semiconductor wafer and other parameters can affect and alter the dimensions of the features of some die on the wafer, so that the features formed do not meet the target dimensions, for example, which reduces the yield. In some applications, for example, it is important that features have substantially the same dimensions across a semiconductor wafer for every die on the workpiece, for example.

Thus, what are needed in the art are improved process control methods and systems for the fabrication of semiconductor devices.

### SUMMARY OF THE INVENTION

These and other problems are generally solved or circumvented, and technical advantages are generally achieved, by preferred embodiments of the present invention, which provide novel process control systems and methods for the manufacture of semiconductor devices. Embodiments of the present invention provide methods of forming features that have substantially the same dimensions for each die across a semiconductor workpiece.

In accordance with a preferred embodiment of the present invention, a process control method includes affecting a first semiconductor device using a first process, measuring an effect of the first process on the first semiconductor device, and affecting the first semiconductor device using at least one second process. The method includes measuring an effect of the at least one second process on the first semiconductor device, and feeding forward and feeding back the measured effect of the first process and the measured effect of the at least one second process on the first semiconductor device. The first process, the at least one second process, or both the first process and the at least one second process are altered based on the fed forward and fed back measured effects of the first process and the at least one second process. A second semiconductor device is affected using the altered first process and/or the altered at least one second process. The second semiconductor device has fewer wafer-to-wafer and die-to-die variations in critical dimensions of features than the first semiconductor device.

The foregoing has outlined rather broadly the features and technical advantages of embodiments of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a block diagram of a less-preferred embodiment of the present invention, wherein a process control system includes a feed-forward loop after a lithography process critical dimension measurement and a feedback loop after an etch process critical dimension measurement;

FIG. 2 shows a top view of a semiconductor wafer patterned utilizing the process control system shown in FIG. 1, wherein the features of die formed on the wafer comprise non-uniform critical dimensions across the surface of the wafer;

FIG. 3 shows a cross-sectional view of the features of the die shown in FIG. 2, wherein some features are larger than a target critical dimension and some features are smaller than the target critical dimension;

FIG. 4 shows a block diagram of a preferred embodiment of the present invention, wherein a process control system includes a plurality of feed-forward loops and a plurality of feedback loops after critical dimension measurements for a first process and a second process;

FIG. 5 shows a lithography system that may be used to perform the first process shown in FIG. 4;

FIG. 6 shows a measurement device that may be used to measure the critical dimensions of a layer of photoresist that has been patterned using the lithography system of FIG. 5;

FIG. 7 shows an etch system that may be used to perform the second process shown in FIG. 4;

FIG. 8 shows a measurement device that may be used to measure the critical dimensions of a patterned material layer that has been etched using the etch system of FIG. 7;

FIG. 9 shows a top view of a semiconductor wafer patterned utilizing the novel process control system shown in FIG. 4, wherein features of the die formed on the wafer comprise uniform critical dimensions across the surface of the wafer;

FIG. 10 shows a cross-sectional view of the features of the die shown in FIG. 9, wherein the features of each die comprise a uniform critical dimension across the semiconductor wafer; and

FIG. 11 illustrates a computing device that may be coupled to the various system components to manage the data and information being collected and fed forward and back in the process control system, in accordance with a preferred embodiment of the present invention.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that embodiments of the present invention provide many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely, process control systems and methods for patterning material layers of semiconductor devices by subtractive etch processes. Embodiments of the invention may also be applied, however, to other applications where material layers are patterned, such as damascene processes, wherein an insulating material is patterned, and a conductive material is deposited to fill the patterns in the insulating material, for example. Embodiments of the present invention may also be applied to deposition processes, chemical-mechanical polishing (CMP) processes, polishing processes, implantation processes, heating processes, reduction processes, cleaning processes, growth processes, treatment processes, or other processes used in the fabrication of semiconductor devices, as examples.

In the manufacturing of integrated microelectronic circuits, it is desirable to pattern certain features independently of the environment they are in on the workpiece, e.g., regardless of the region of the workpiece the features or die are located in. For example, generally, features with a predetermined target dimension should be manufactured as closely as possible to the target dimension, regardless of what the other surrounding features are, regardless of their position on the semiconductor wafer, and regardless of density of the features, as examples. However, achieving a target dimension for all die across a semiconductor wafer may be problematic and difficult to achieve.

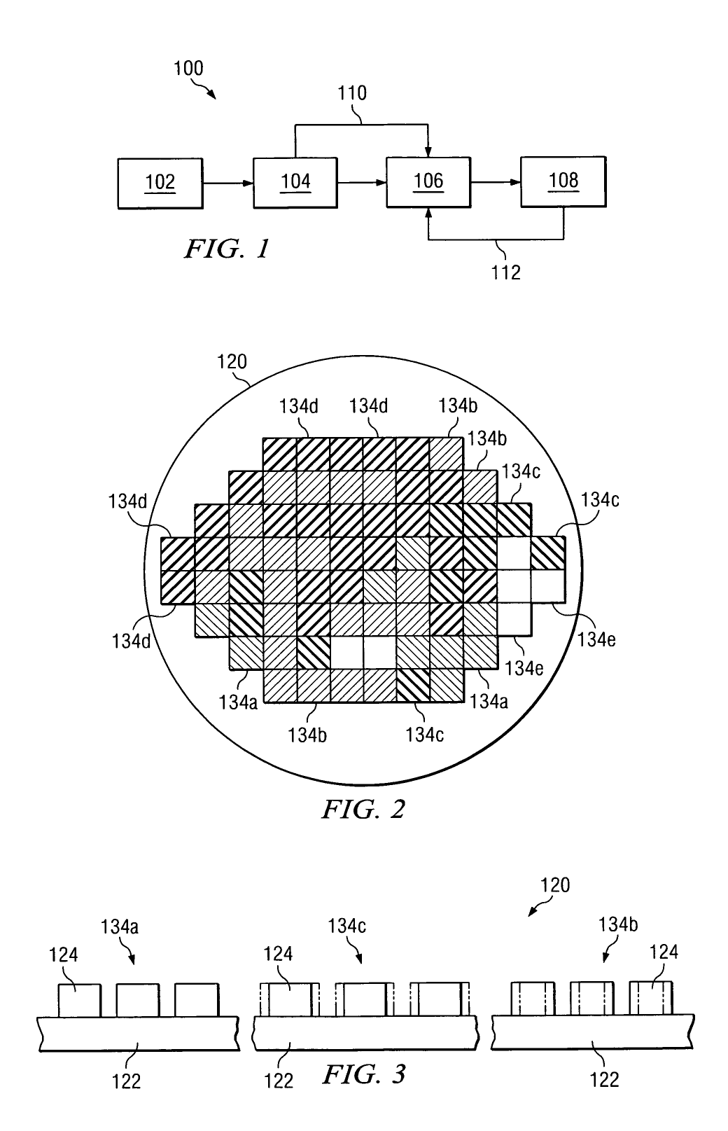

FIG. 1 shows a block diagram of a less-preferred embodiment of the present invention, wherein a process control system 100 includes a feed-forward loop 110 after a lithography process 102 critical dimension measurement 104 and a feedback loop 112 after an etch process 106 critical dimension measurement 108. One or more semiconductor wafers are processed by depositing a layer of photoresist over a material layer to be patterned. The layer of photoresist is patterned, e.g., by exposing the layer of photoresist to light through a mask. The pattern in the layer of photoresist is measured, e.g., the patterns for the smallest feature size are measured (e.g., by measurement system 104), and compared to a predetermined target dimension, which is also referred to as a target critical dimension (CD). The information is fed forward using a feed-forward loop 110 to the etch process 106 so that adjustments may be made in the etch process 106.

Then the etch process 106 is performed, wherein the patterned layer of photoresist is used as a mask while the underlying material layer is etched away, e.g., using a reactive ion etch (RIE) etch process or other etch process. The layer of photoresist is then removed or stripped from the semiconductor wafer, and measurements are made of features formed in the material layer by measurement system 108. This second CD measurement is compared to the predetermined target dimension for CD, and the second measurement information is fed back to the etch process or tool 106, as shown at 112, so that adjustments may be made in the etch process 106 for the processing of subsequent semiconductor wafers to be processed.

A problem with the process control system 100 shown in FIG. 1 is that while some wafer-to-wafer variations in CD may be adjusted for and corrected, chip-to-chip (e.g., die-to-die) variations across a single semiconductor wafer cannot be accommodated for and corrected using the process control system 100. The information from the CD measurements made of the layer of photoresist after the lithography process 102 (e.g., by measurement system 104) and of the material layer (e.g., by measurement system 108) after the etch process 106 is used to determine the amount of RIE trim adjusting to implement in a subsequent etch process 106, for example. However, adjusting the amount of trim and other parameters of the etch process 106 does not control or adjust chip-to-chip variations, which is a major contributor to the chip mean tolerance (CMT), which may be represented by Equation 1, as an example:
CMT²=(chip-chip)²+(wafer-wafer)²+(lot-lot)² Equation1:

FIG. 2 shows a top view of a semiconductor wafer 120 patterned utilizing the process control system shown in FIG. 1, wherein the features of die 134a, 134b, 134c, 134d, and 134e formed on the wafer 120 comprise non-uniform critical dimensions across the surface of the wafer 120. FIG. 2 illustrates a typical final CD distribution map of a semiconductor wafer. The die 134a, 134b, 134c, 134d, and 134e are hatched differently according to the measured CD of features of each die 134a, 134b, 134c, 134d, and 134e in FIG. 2. Die 134a comprise features that are the target dimension for the CD. Die 134b comprise features that are slightly smaller than the target CD. Die 134c comprise features that are slightly larger than the target CD. Die 134d comprise features that are substantially smaller than the target CD, and die 134e comprise features that are substantially larger than the target CD.

FIG. 3 shows a cross-sectional view of some of the features 124 of the die 134a, 134b, and 134c shown in FIG. 2 across a surface of a semiconductor wafer 120. The wafer 120 includes a workpiece 122 and features 124 formed in a material layer disposed over the workpiece 122. Three die 134a, 134b, and 134c are shown in FIG. 3. Die 134a comprises features 124 that are the target CD, whereas die 134b comprises features 124 that are too small, shown in phantom, and die 134c comprises features 124 that are too large, also shown in phantom, compared to the target CD.

It is desirable in many semiconductor applications for certain features of all die across a surface of a semiconductor workpiece 122 to be the same size, e.g., the target CD, for the semiconductor devices to function correctly. For example, if the features 124 formed in the material layer comprise gates of transistors, the size of the features 124 affects the resistance, which affects the performance of the transistors. Typically, a particular gate length is desired in the manufacture of transistors. If the features or gates 124 are too small or large, devices (such as die 134d and 134e in FIG. 2, and also die 134b and 134c, in some applications) may have to be scrapped or discarded, because their performance may be inadequate or unpredictable, for example.

In some applications, e.g., for semiconductor devices having larger minimum feature sizes or CD, the process control system 100 shown in FIG. 1 may be adequate. The process control system 100 shown is a straight-forward approach for adjusting wafer-to-wafer and lot-to-lot variations in CD of features of die manufactured. Lithography drifts in CD are compensated for by the feed-forward loop 110, by adjusting the RIE trim conditions. RIE chamber drifts in CD are compensated for by the feedback loop 112, also by adjusting the RIE trim conditions.

However, the process control system 100 shown in FIG. 1 may be ineffective when implemented in a semiconductor device manufacturing facility wherein the etch process 106 utilizes reduced trim processes, for example. The process control system 100 adjusts only the RIE tool 106 to accommodate for both lithography system 104 and RIE process/tool 106 shifts.

Furthermore, chip-to-chip variations are not addressed using the process control system 100 shown in FIG. 1. Even if a dual-zone RIE process 106 is implemented, chip-to-chip variations in CD may not be reduced, because the chip-to-chip variations may not be due to a center/edge problem with the wafer, for example. The final CD measurements may be affected by CD distribution and trim distribution within an etch chamber, which can be shifted by both lithographic and etch tools and processes, for example.

Thus, what are needed in the art are improved process control systems and methods for semiconductor device manufacturing, wherein chip-to-chip variations in CD may be accommodated for and eliminated, as well as wafer-to-wafer and lot-to-lot variations.

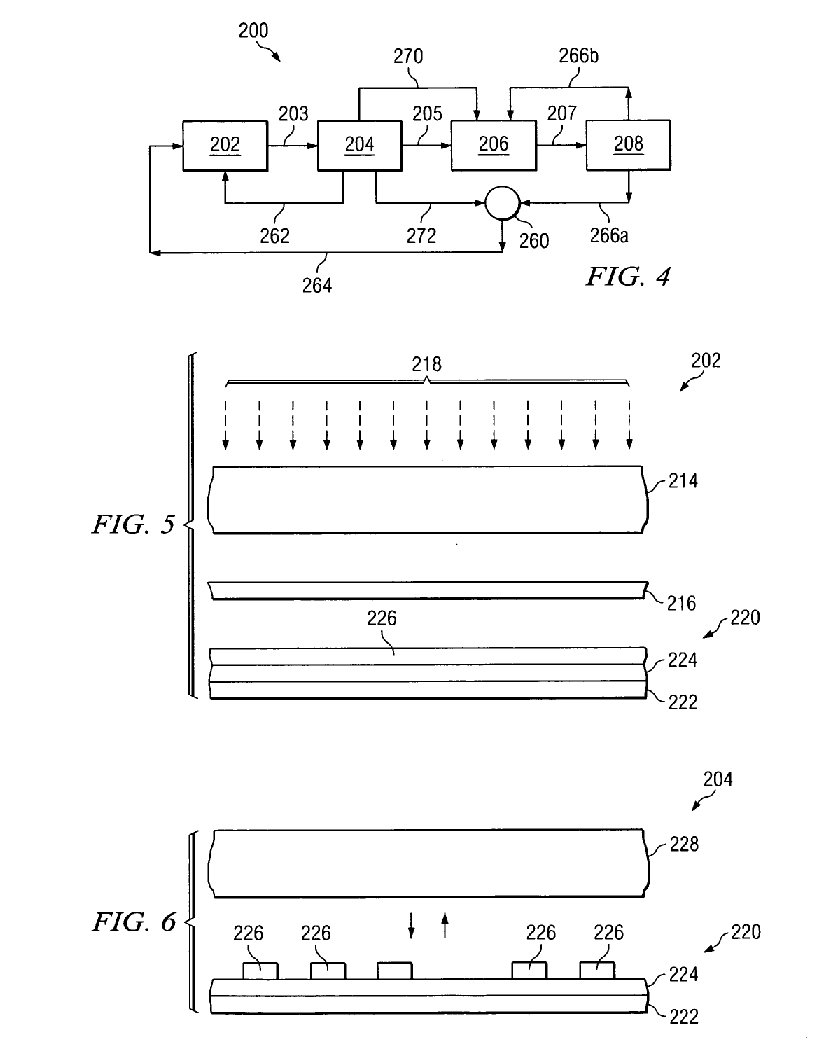

FIG. 4 shows a block diagram of a preferred embodiment of the present invention, wherein a process control system 200 includes a plurality of feed-forward loops 270, 272, 266a and a plurality of feedback loops 262, 264, 266b after critical dimension measurements 204 and 208 for first and second processes 202 and 206. The process control system 200 includes a first process 202 and a second process 206. The first process 202 preferably comprises a lithography process and the second process 206 preferably comprises an etch process, in one embodiment, for example. The process control system 200 includes CD measurement processes 204 and 208 that are used to measure CD after the first process 202 and the second process 208 are performed, as shown.

The first process 202 is performed on a semiconductor device. The information from the first CD measurement 204 after the first process 202 (e.g., shown at 203) is fed back to the first process 202, as shown at feedback loop 262. The first process 202 is preferably adjusted based on the measurement information. The information from the first CD measurement 204 is preferably also fed forward to the second process 206, as shown at feed-forward loop 270, and also to a comparator 260, as shown at feed-forward loop 272.

After the first CD measurement 204 (shown at 205), then the second process 206 is performed on the semiconductor device. After the second process 206 (shown at 207), then a second CD measurement 208 is taken. The information from the second CD measurement 208 is fed back to the second process 206, as shown at 266b. The information from the second CD measurement 208 is also fed forward to the comparator 260, as shown at 266a. The information from the first CD measurement 204 and the second CD measurement 208 are compared by the comparator 260, and the information is fed back to the first process 202, as shown at feedback loop 264.

The information from the plurality of feed-forward loops 270, 272, 266a and the plurality of feedback loops 262, 264, 266b is used to adjust parameters of the first process 202 and the second process 206. For example, if the first process 202 comprises a photolithography process, the information from feedback loops 262 and 264 is used to adjust the photolithography process to reduce CD variations from chip-to-chip, wafer-to-wafer, and lot-to-lot.

In one embodiment, for example, the first process 202, which may comprise a lithography process, may be changed for some die but not for other die on the semiconductor device in response to the information from feedback loops 262 and 264, for example. The lithography system 202 may comprise a stepper that is adapted to expose one or more die at a time, for example. The exposure dose or focus may be altered for die at different positions on a semiconductor wafer surface, to achieve the same target CD for all die across a semiconductor surface, for example.

Next, an embodiment of the present invention will be described, wherein the first process 202 comprises a lithography process, and wherein the second process 206 comprises an etch process, with reference to FIGS. 5 through 8. FIGS. 5 through 8 show cross-sectional views of a method of patterning a material layer 224 of a semiconductor device 220 in accordance with a preferred embodiment of the present invention. First, a workpiece 222 is provided, as shown in FIG. 5. The workpiece 222 may include a semiconductor substrate comprising silicon or other semiconductor materials covered by an insulating layer, for example. The workpiece 222 may also include other active components or circuits, not shown. The workpiece 222 may comprise silicon oxide over single-crystal silicon, for example. The workpiece 222 may include other conductive layers or other semiconductor elements, e.g., transistors, diodes, etc. Compound semiconductors, GaAs, InP, Si/Ge, or SiC, as examples, may be used in place of silicon. The workpiece 222 may comprise a silicon-on-insulator (SOI) substrate, for example.

A material layer 224 is deposited or formed over the workpiece 222 (e.g., in a previous deposition process, not shown). The material layer 224 may comprise an insulating material, a semiconductive material, a conductive material, or multiple layers or combinations thereof, as examples. In a preferred embodiment, the material layer 224 comprises a semiconductive material such as polysilicon, as an example. The material layer 224 may comprise a single layer of material or multiple layers of materials, for example. The material layer 224 may comprise a thickness of about 500 nm or less, although alternatively, the material layer 224 may comprise other dimensions, e.g., about 500 nm or greater, for example.

In some embodiments, the material layer 224 may comprise a semiconductive material that will be subtractively etched to form gates of transistors, for example. In this embodiment, preferably, a gate dielectric material (not shown) is formed over the workpiece 222 before the gate material 224 is deposited, for example. Alternatively, in other embodiments, the material layer 224 may comprise an insulating material that is patterned and later filled with a conductive material, e.g., in a damascene process.

After the material layer 224 is deposited, an optional anti-reflective coating (ARC) (not shown) may be deposited over the material layer 224. The ARC may comprise a thickness of about 200 nm or less, and more preferably comprises a thickness of about 90 nm in one embodiment, as an example, although alternatively, the ARC may also comprise other dimensions.

A layer of photosensitive material 226 is formed over the ARC, or over the material layer 224, if an ARC is not used, as shown in FIG. 5. The layer of photosensitive material 226 may comprise a photoresist having a thickness of about 250 nm or less, and more preferably comprises a thickness of about 195 nm in one embodiment, for example, although alternatively, the layer of photosensitive material 226 may comprise other dimensions.

The workpiece 222 is placed on a support, not shown. The workpiece 222 may be placed on a steppable stage of a lithography system, for example.

A lithography mask 216 is provided, as shown in FIG. 5. The lithography mask 216 may comprise a binary mask, an alternating phase shifting mask, or other types of masks, for example. The lithography mask 216 may comprise a plurality of substantially transparent regions that permit light 218 or energy to pass through the mask 216, and a plurality of opaque or translucent regions that block at least a portion of the light 218, for example.

The lithography mask 216 is then used to pattern the layer of photosensitive material 226 on the semiconductor device 220 using light 218 or energy. The light 218 may be directed at the semiconductor device 220 using a lens system 214, for example. The layer of photosensitive material 226 is developed, and exposed regions or unexposed region (depending on if the layer of photosensitive material 226 comprises a positive or negative photoresist, for example) of the layer of photosensitive material 226 are removed, as shown in FIG. 6.

The layer of photosensitive material 226 may alternatively be patterned using a projection lithography system 214 or other type of lithography system, such as an immersion lithography system, for example. The opaque material of the mask 216 comprises the pattern that will be transferred to the material layer 224 of the semiconductor device 220. For example, the lithography mask 216 may be patterned with a pattern for features having the critical dimension.

FIG. 6 shows a measurement device that may be used for the first CD measurement 204 of a layer of photosensitive material 226 that has been patterned using the lithography process 202 of FIG. 5. The measurement device preferably comprises a scatterometer 228, in some embodiments, although alternatively, other measurement devices may also be used to measure the CD. The measurement device may emit a signal or light towards the patterned layer of photosensitive material 226, and the measurement device may be adapted to receive a reflected signal or light from the semiconductor device 220 and measure the dimensions of the patterned layer of photosensitive material 226.

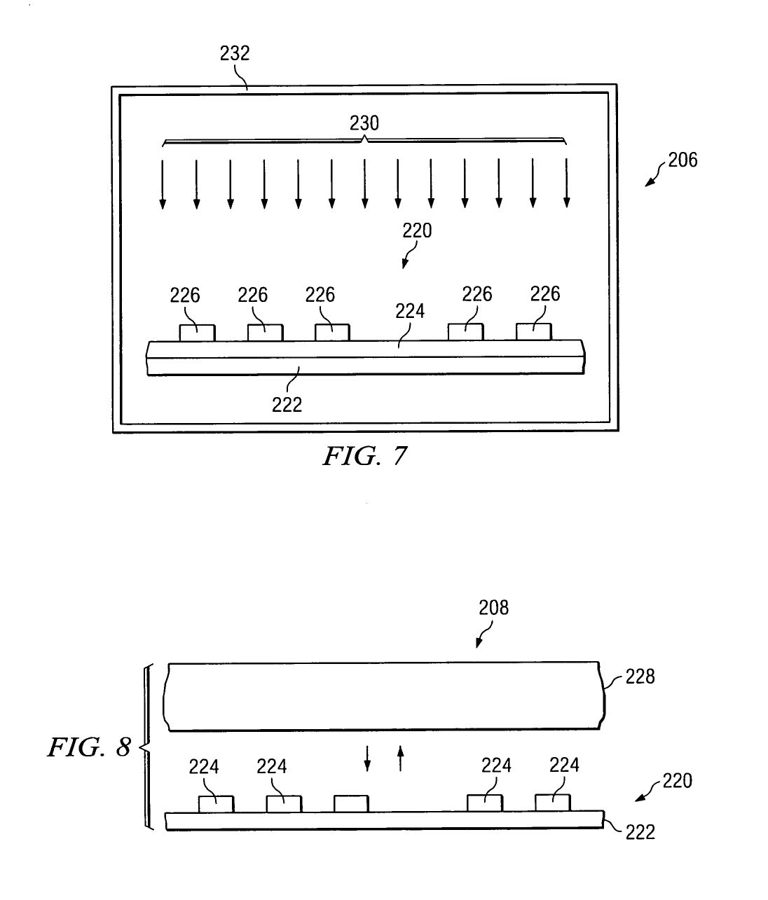

FIG. 7 shows an etch system that may be used to perform the second process 206 shown in FIG. 4. The etch system includes a chamber 232 adapted to contain the chemicals, e.g., gases, liquids and other substances used in the etch process, and the etch system includes a wafer support (not shown). Wafer handlers may be present to move the semiconductor device 202 within the chamber 232, also not shown.

The semiconductor device 220 is placed in the chamber 232, and the layer of photosensitive material 226 is then used as a mask while the material layer 224 is patterned (e.g., exposed portions of the material 224 not protected by the layer of photosensitive material 226 are removed using an etch process), transferring the pattern of the layer of photosensitive material 226 to the material layer 224, as shown in FIG. 7. First, the ARC (not shown) is etched away or opened, and then an etch process 230 is used to etch away exposed portions of the material layer 224, leaving portions of the material layer 224 left residing under the layer of photosensitive material 226. The etch process 230 preferably comprises a dry etch process suitable for removing the type of material of the material layer 224 to be patterned, for example, although alternatively, the etch process 230 may comprise a wet etch process or other types of etch processes.

The layer of photosensitive material 226 is then stripped or removed, and the ARC is removed, as shown in FIG. 8.

Note that the material layer 224 may include a hard mask disposed over a layer of material to be patterned, not shown. The hard mask may comprise an insulating material, such as SiO₂, SiₓN_{y}, combinations thereof, or other materials, for example. In some embodiments, for example, the layer of photosensitive material 226 may be patterned using the lithography mask, and then the layer of photosensitive material 226 is used to pattern the hard mask. The layer of photosensitive material 226 may then be removed, and the hard mask is used to pattern the material layer, for example. Or, alternatively, both the layer of photosensitive material 226 and the hard mask may be used to pattern the material layer 224, for example. The hard mask may be left remaining, or it may be removed, for example.

FIG. 8 illustrates a measurement device that may be used for the second CD measurement 208 of the patterned material layer 224 that has been etched using the etch process 206 shown in FIG. 7. The measurement device preferably comprises a scatterometer 228, in some embodiments, although alternatively, other measurement devices may also be used to measure the CD of the patterned material layer 224. The measurement device may emit a signal or light towards the patterned material layer 224, and the measurement device may be adapted to receive a reflected signal or light from the semiconductor device 220 and measure the dimensions of the material layer 224. The scatterometer 228 may comprise the same scatterometer 228 used in the first measurement device 204, for example.

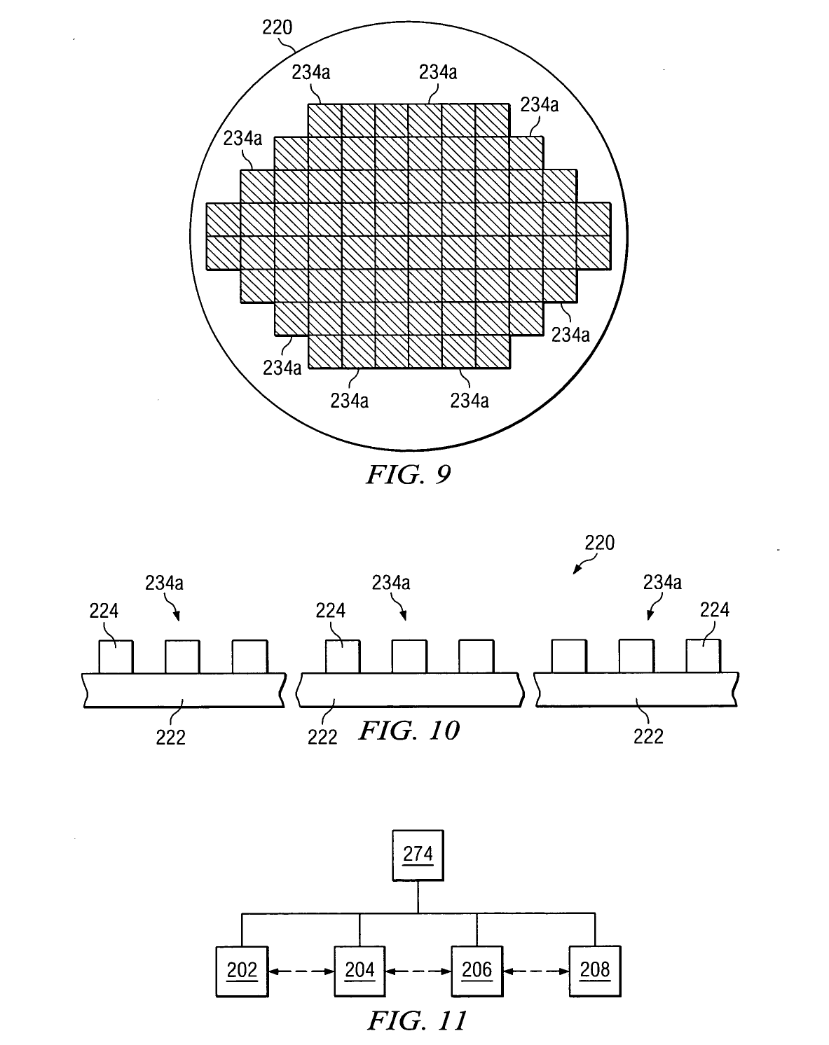

FIG. 9 shows a top view of a semiconductor wafer 220 patterned utilizing the novel process control system 200 shown in FIG. 4, wherein features of the die 234a formed on the wafer 220 comprise uniform critical dimensions across the surface of the wafer 220. The novel feed-forward loops 270, 272, 266a and feedback loops 262, 264, 266b of the process control system 200 are used to adjust parameters of the first process 202 and the second process 206 to produce die 234a comprising features having substantially the same, uniform CD for each die 234a on the wafer 220. Advantageously, embodiments of the present invention may accommodate and adjust for die-to-die variations, as well as wafer-to-wafer and lot-to-lot variations. The wafer 220 is divided into a grid pattern, wherein each grid box corresponds to a die or a portion of die, for example.

FIG. 10 shows a cross-sectional view of the features of the die 234a shown in FIG. 8, illustrating that the features 224 of each die 234a comprise a uniform critical dimension.

FIG. 11 illustrates a computing device 274 that may be coupled to the various system components to manage the data and information being collected and fed forward and back, in accordance with a preferred embodiment of the present invention. The computing device 274 may comprise a single piece of equipment, or may comprise a plurality of computers or subsystems that are integrated and coupled to the other components, such as the systems or devices used to perform the first process 202, second process 206, and measurement processes 204 and 208. The computing device 274 may include a processor adapted to perform calculations and comparisons of the information fed forward and fed back, and analyze the data collected by the CD measurement devices. The computing device 274 may include the comparator 260 shown in FIG. 4, for example. The computing device 274 preferably also includes a memory adapted to store the target CD dimensions and the information fed forward and fed back in accordance with embodiments of the present invention. The computing device 274 may be adapted to store a plurality of recipes for particular semiconductor device designs and various systems, devices, methods, and processes 202, 204, 206, and 208 used to process the semiconductor devices, for example. Embodiments of the present invention may be implemented in software in an existing or additional computing device 274 within a fabrication facility for semiconductor devices, for example.

Referring again to FIG. 4, preferably, the process control system 200 is implemented on at least two semiconductor devices 220. In some embodiments, the process control system 200 is iteratively implemented on a plurality of semiconductor devices 220, lots of semiconductor devices 220, or runs of semiconductor devices 220, with each successive semiconductor device 220, lot, or run having an improved CD control compared to the previous semiconductor devices 220, lots or runs processed, due to the plurality of feed-forward loops 270, 272, 266a and the plurality of feedback loops 262, 264, 266b of the novel process control system 200.

Next, the novel plurality of feed-forward loops 270, 272, 266a and the plurality of feedback loops 262, 264, 266b of the process control system 200 will be described further, in an embodiment wherein the first process 202 comprises a lithography process 202 performed in a lithography system and the second process 206 comprises an etch process 206 performed in an etch system. The feedback loop 262 provides correction of across-wafer 220 systematic variations due to the lithography process 202 of the lithography system, by changing the individual dose and/or focus for each image field of the lithography system or semiconductor device, according to the feedback loop 262 information. The feed-forward loop 270 provides correction of incoming wafer-to-wafer variations in the lithography system or lithography process 202 of the lithography system by tuning the etch process 206 parameters of the etch system. The feedback loop 264 provides correction of RIE chamber drift, an etch tool, and/or an etch process 206 from the etch system-related systematic variations in across-wafer CDs of the semiconductor device by changing the lithography process 202 conditions of the lithography system. The feedback loop 266b provides etch tool drift and CD distribution feedback to tune the etch process 206 of the etch system, e.g., by using multi-zone chuck temperatures or dual injection gases. Note that the feedback loop 262 from the first measurement process 204 to the lithography process 202 may also include an average dose feedback that does not indicate or quantify die-to-die and wafer-to-wafer variations, for example.

Thus, embodiments of the present invention achieve technical advantages by providing novel advanced process control schemes with multiple feed-forward and feedback loops to enable corrections for systematic variations in across-wafer CD distributions of lithography and etch processes (e.g., providing correction per image field) in order to reduce final CD variations across a wafer 220; in particular, chip-to-chip contribution to CD error budget. The complexity of the present process control scheme and frequency of corrections may depend on the frequency and amplitude of changes in CD distribution variation, for example. Embodiments of the present invention enable within-image-field corrections via utilization of exposure dose and/or exposure tilt corrections, as examples, to allow corrections for systematic final CD and CDs within individual exposure fields, for example.

Embodiments of the present invention are particularly advantageous and provide more flexibility with regard to CD adjustments via exposure focus and/or exposure tilt with relatively wider depth of focus (DOF) values when implemented in immersion lithography systems, for example. In an immersion lithography system, a fluid is disposed between the lithography mask and the semiconductor device during the lithography process, for example (not shown).

Embodiments of the present invention may be implemented in advanced process control (APC) systems and/or software, for example. Embodiments of the present invention may be implemented in hardware, software, or both hardware and software, for example.

Embodiments of the present invention may be implemented at an initial set-up of a process for a particular semiconductor device design. A single wafer or a few wafers may be processed using the process control system 200 shown in FIG. 4, until the CD of features for die across a wafer is substantially the same. The set-up or recipe determined using the process control system 200 may then be stored in a memory of the computing device 274 shown in FIG. 11, for example, and retrieved for use in the processing of one or more lots of the particular semiconductor device in production, for example. The process control system 200 may be also be implemented periodically, to re-adjust the parameters to maintain uniform CD, for example.

The measurement of CD 204 and 208 may comprise sampling a predetermined number of features of each die across a semiconductor device, or alternatively may comprise testing each feature of all or some die across a semiconductor device in some applications, for example.

After the CD measurement 204 step, in some embodiments, if the CD measurement is determined to be excessively larger or smaller than the target CD dimension, the patterned layer of photosensitive material 226 (see FIG. 6) may be removed or stripped, and another layer of photosensitive material 226 may be deposited. The first process 202 and the CD measurement 204 is then repeated on the new layer of photosensitive material 226. The first process 202 and the CD measurement 204 may be repeated (e.g., by stripping the layer of photosensitive material 226 and depositing a fresh layer of photosensitive material 226) until the CD measurement 204 of the patterned layer of photosensitive material 226 is determined to be acceptable. This embodiment results in a cost savings, because patterning the material layer 224 with features having an unacceptable CD measurement is avoided. The process control method is then continued by etching the material layer 224 of the semiconductor device 220 using the layer of photosensitive material 226 as a mask, implementing the second CD measurement 208, and feeding forward and back the second CD measurement 208, as described herein, to adjust the focus, dose, and exposure tilt to achieve a uniform CD of features of die across the entire wafer.

Some examples of embodiments of the present invention will next be described. First, an embodiment wherein there is slow drift of both across-wafer CD distribution and final CD average will be described. For several or all wafers of a first lot, first, scatterometric measurement of lithography and final CD CMT for all chips, or a selected number of chips, if information of expected across-wafer trends already known, is taken, e.g., using CD measurement processes 204 and 208, as shown in FIG. 4. Second, optionally, data fitting of lithography and final CD maps across the wafer is performed, e.g., an average of all measured wafers, with interpolations, if required. Third, a calculation of across-wafer map per die of the difference to the final target CD is made (e.g., the output 264 of the comparing operation or comparator 260). Fourth, a calculation of required dose corrections per individual die is performed, to minimize distribution of deviations from final CD target across the wafer (e.g., feedback loop 264), utilizing predetermined dependence of lithography and final CD measurements 204 and 208 on the exposure dose.

Possible incorporations in the exemplary procedure mentioned above include a feed-forward correction (feed-forward loop 270) of average lithography CD of each wafer to an etch tool, in order to minimize wafer-to-wafer variations, and feed-forward of an average lithography CD of a “send ahead” wafer to correct across-wafer lithography CD distribution of following wafers. Note that it is possible in some embodiments that across-wafer CD variation trends of the lithography and etch processes may compensate each other, for example.

A second embodiment includes a scenario wherein there is slow drift of both across-wafer CD distribution and final CD average. For subsequent lots, first, feedback correction (e.g., feedback loop 262) is made of the lithography dose for individual die to minimize systematic across-wafer CD trends input from a previous lot, if required. Second, feedback correction (e.g., feedback loop 266b) is made to the etch tool to adjust tool parameters, such as flows in individual zones of multiple-zone gas distribution plates or temperatures in a multi-zone electrostatic chuck (ESC), in order to reduce radial non-uniformities in the etch process, for example. Third, scatterometric measurement 208 of final CD CMT is made for every wafer or for a defined number of wafers in a lot. This information may be fed forward to the next lot for adjustment of RIE trim conditions in the event that the CD average shifts. Fourth, verification is made of the stability of distribution of minimized across-wafer differences of final CD vs. target CD. If a statistically significant deviation to the previous lot (e.g., defined by a trigger criterion or trend over time) is observed, then the execution of the first step (feedback loop 262) is repeated with the next lot.

A third embodiment includes a scenario wherein there is slow drift of both across-wafer CD distribution and a final CD average and RIE process with less trim. First, correction of exposure doses of individual die to minimize systematic across-wafer variations is made, if required. Second, feedback to the lithography tool is made, if required, e.g., feedback loop 262. Third, a feed-forward is made of final CDs to the next lot for adjustment of RIE trim conditions. Fourth, a verification of stability of remaining final across-wafer CD variations is made, and fifth, the first step (correction of exposure doses) is repeated for the next lot, if needed.

In a fourth embodiment, there may be slow drift of across-wafer CD distribution and a fast drift of final CD average. In this embodiment, first, correction of exposure doses of individual die to minimize systematic across-wafer variations is made, if required (feedback loop 262). Second, lithography CD measurements (204) are made on every wafer for feed-forward correction to the etch tool, in order to minimize lithography wafer-to-wafer, if a benefit is expected (feed-forward loop 270). Third, final CD measurements are made on every wafer for feedback to the etch tool, in order to minimize impact of drifts in etch conditions, e.g., to reduce wafer-to-wafer final CD variation (feedback loop 266b). Fourth, verification of stability of remaining final across-wafer variations may be made, and fifth, the first step above made be repeated for the next lot, if needed.

In a fifth embodiment, there may be fast drift of both across-wafer CD distribution and of final CD average. In this embodiment, first, for every lot, correction of exposure doses of individual die is made, in order to minimize systematic across-wafer variations, or at least make corrections in shorter intervals. Second, lithography CD measurements are made on every wafer for feed-forward correction to the etch tool, in order to minimize lithography wafer-to-wafer variations. Third, final CD measurements 208 are made on every wafer for feedback to the etch tool for the next wafer, in order to minimize drifts in the etch conditions, e.g., wafer-to-wafer final CD variation. Fourth, verification is made of the stability of remaining final across-wafer variations, and fifth, the first step may be repeated for the next lot, if needed.

Thus, one or more feed back loops 262, 266b, 264, and one or more feed-forward loops 270, 272, 266a may be implemented and utilized selectively in accordance with embodiments of the invention.

Advantages of embodiments of the present invention include benefits not only for minimization of wafer-to-wafer (W2W) and lot-to-lot (R2R) CD variation, but also for minimization of die-to-die (C2C) variations, as well. A higher integrated level integrated metrology module (IMM) and more universal advanced process controls for CD are achieved by embodiments of the present invention.

The novel embodiments of the present invention may be implemented in semiconductor processing in any two or more interactive processes where the systematic variation induced by such interactions or variations introduced by one process can be minimized. Embodiments of the present invention may be implemented in software that enables the feedback and feed-forward calculations described herein. The calculations may be made in the subroutines of existing tools, or in new tools implemented specifically to implement embodiments of the present invention described herein, for example.

Referring again to FIG. 4, if the second process 206 comprises an etch process, the information fed forward and fed back in accordance with embodiments of the present invention may be used to adjust trim etch processes of the etch process, for example. In some applications and etch processes, “trim” etch processes are often used. In a trim etch process, rather than attempting to transfer the dimensions of the lithography mask 216 (see FIG. 5) as closely as possible to a material layer 224, the lithography mask 216 patterns are intentionally trimmed to a shorter or narrower dimension than the mask dimension during the etching process.

For example, in some applications where a material layer 224 will be patterned to form gates of transistors, a trim etch process may be used that trims the gate lengths (typically the smallest dimension in an x or y direction of a transistor gate from a top view of a semiconductor wafer) by about 30 nm to 40 nm. The trim portion of the etch process is typically adjusted by adding more of particular gases, such as 0₂, to the etch process, or by adjusting the pressure, as examples. During a trim etch process having a high trim amount, the etch component tends to outweigh the deposition component, for example.

Note that only two processes 202 and 206 are shown in FIG. 4; however, three or more processes 202 and 206 may be implemented, with a plurality of feedback and feed-forward loops and CD measurements, included for each process 202 and 206, as described herein. A first process 202 and at least one second process 206 may be implemented in the process control system 200, for example.

Embodiments of the present invention are described herein with reference to optical lithography systems and masks, and may be implemented in lithography systems that utilize ultraviolet (UV) or extreme UV (EUV) light, as examples. The novel process control systems and methods described herein may also be used in non-optical lithography systems, x-ray lithography systems, interference lithography systems, short wavelength lithography systems, Scattering with Angular Limitation in Projection Electron-beam Lithography (SCALPEL) systems, and immersion lithography systems, or other lithography systems that utilize lithography masks or direct patterning, as examples.

The features 224 described herein may comprise transistor gates, conductive lines, vias, capacitor plates, and other features, as examples. Embodiments of the present invention may be used to pattern features 224 of memory devices, logic circuitry, and/or power circuitry, as examples, although other types of ICs may also be fabricated using the novel patterning methods and mask sets described herein.

Advantages of embodiments of the invention include providing novel methods of patterning features in a material layer, wherein the features comprise the same critical dimension across a surface of a workpiece, regardless of the region of the workpiece the features are formed in. Thus, circuits and devices on each die across a surface of a semiconductor wafer advantageously comprise substantially the same performance characteristics, such as speed, resistance, current, voltage, and other parameters, as examples. Increased process control and increased semiconductor device yields are achieved by the embodiments of the present invention described herein.

The process control systems and methods described herein produce semiconductor wafers wherein critical dimensions of die across a wafer surface are maintained within acceptable, tight tolerances. The process control systems and methods may be implemented periodically or continuously, to maintain CD control in the fabrication of semiconductor devices, for example.

Although embodiments of the present invention and their advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A process control method, comprising:
affecting a first semiconductor device using a first process;
measuring an effect of the first process on the first semiconductor device;
affecting the first semiconductor device using at least one second process;
measuring an effect of the at least one second process on the first semiconductor device;
feeding forward and feeding back the measured effect of the first process and the measured effect of the at least one second process on the first semiconductor device;
altering the first process, the at least one second process, or both the first process and the at least one second process based on the fed forward and fed back measured effects of the first process and the at least one second process; and
affecting a second semiconductor device using the altered first process and/or the altered at least one second process, wherein the second semiconductor device has fewer wafer-to-wafer and die-to-die variations in critical dimensions of features than the first semiconductor device.

2. The method according to claim 1, wherein the first process comprises a lithography process, and wherein the at least one second process comprises an etch process, wherein altering the first process comprises reducing die-to-die variations, and wherein altering the second process comprises reducing wafer-to-wafer variations.

3. The method according to claim 2, wherein the first process comprises sequentially exposing a plurality of portions of the first semiconductor device, wherein altering the first process comprises altering an exposure process for a first portion of the second semiconductor device, but not altering an exposure process for a second portion of the second semiconductor device.

4. The method according to claim 1, further comprising:
affecting the second semiconductor device using the altered first process;
measuring an effect of the altered first process on the second semiconductor device;
affecting the second semiconductor device using the altered at least one second process;
measuring an effect of the altered at least one second process on the second semiconductor device;
feeding forward and feeding back the measured effect of the altered first process and the measured effect of the altered at least one second process on the second semiconductor device;
further altering the first process, the at least one second process, or both the first process and the at least one second process; and
affecting a third semiconductor device using the further altered first process and/or the further altered at least one second process, wherein the third semiconductor device has fewer wafer-to-wafer and die-to-die variations than the second semiconductor device.

5. The method according to claim 1, wherein the first process or the at least one second process comprise a lithography process, an etch process, a deposition process, a chemical mechanical polishing (CMP) process, a polishing process, an implantation process, a heating process, a reduction process, a cleaning process, a growth process, or a treatment process.

6. The method according to claim 1, wherein feeding forward and feeding back the measured effect of the first process and the measured effect of the at least one second process on the first semiconductor device comprise:
feeding back the measured effect of the first process to the first process;
feeding forward the measured effect of the first process to the at least one second process;
feeding back the measured effect of the at least one second process to the at least one second process; and/or
feeding forward the measured effect of the first process and the measured effect of the at least one second process to a comparator, wherein the comparator feeds back compared results of the measured effect of the first process and the at least one second process to the first process.

7. The method according to claim 1, wherein the second semiconductor device has fewer lot-to-lot variations in critical dimensions of features than the first semiconductor device.

8. A method of manufacturing a semiconductor device, the method comprising:
providing a first workpiece, the first workpiece including a first material layer and a first layer of photosensitive material disposed over the first material layer;
providing a target dimension for at least one feature to be formed in the first material layer for a plurality of die;
patterning the first layer of photosensitive material with a pattern for the at least one feature using a first exposure dose, a first focus level, and a first exposure tilt for a plurality of die;
measuring the pattern for the at least one feature of the first layer of photosensitive material for each of the plurality of die;
comparing the measured pattern for the at least one feature of the first layer of photosensitive material to the target dimension for each of the plurality of die;
patterning the first material layer using the first layer of photosensitive material as a mask;
measuring the at least one feature formed in the first material layer for the plurality of die;
comparing the measurement of the at least one feature formed in the first material layer to the target dimension for each of the plurality of die; and
adjusting the first exposure dose to a second exposure dose, adjusting the first focus level to a second focus level, or adjusting the first exposure tilt to a second exposure tilt for at least one of the plurality of die, based on at least the comparison of the measurement of the pattern for the at least one feature of the first layer of photosensitive material to the target dimension.

9. The method according to claim 8, further comprising:
providing a second workpiece, the second workpiece including a second material layer and a second layer of photosensitive material disposed over the second material layer; and
patterning the second layer of photosensitive material with a pattern for the at least one feature using the second exposure dose, second focus level, or the second exposure tilt for the at least one die.

10. The method according to claim 9, further comprising patterning the second material layer using the second layer of photosensitive material as a mask, wherein the at least one feature comprises substantially the target dimension for each die.

11. The method according to claim 9, further comprising:
measuring the pattern for the at least one feature of the second layer of photosensitive material for each of the plurality of die;
comparing the measured pattern for the at least one feature of the second layer of photosensitive material to the target dimension for each of the plurality of die;
patterning the second material layer using the second layer of photosensitive material as a mask, forming at least one feature in the second material layer;
measuring the at least one feature formed in the second material layer for the plurality of die;
comparing the measurement of the at least one feature formed in the second material layer to the target dimension for each of the plurality of die; and
repeating adjusting the second exposure dose to a third exposure dose, adjusting the second focus level to a third focus level, or adjusting the second exposure tilt to a third exposure tilt for at least one the plurality of die, based on at least the comparison of the measurement of the pattern for the at least one feature of the second layer of photosensitive material to the target dimension, until the measurement of the pattern for the at least one feature formed in the second material layer is substantially equal to the target dimension for substantially all of the plurality of features for all of the die.

12. The method according to claim 11, wherein adjusting the second exposure dose to the third exposure dose, adjusting the second focus level to the third focus level, or adjusting the second exposure tilt to the third exposure tilt for each of the plurality of die is also based on the comparison of the measurement of the at least one feature formed in the second material layer to the target dimension for each of the plurality of die.

13. The method according to claim 8, further comprising feeding forward or feeding back a first measurement from measuring the pattern for the at least one feature of the first layer of photosensitive material for each of the plurality of die, or a second measurement from measuring the at least one feature formed in the second material layer for the plurality of die.

14. A semiconductor device manufactured in accordance with the method according to claim 8.

15. A process control system, comprising:
means for affecting a first semiconductor device using a first process;
means for measuring an effect of the first process on the first semiconductor device;
means for affecting the first semiconductor device using at least one second process;
means for measuring an effect of the at least one second process on the first semiconductor device;
means for feeding forward and feeding back the measured effect of the first process and/or the measured effect of the at least one second process on the first semiconductor device;
means for altering the first process, the at least one second process, or both the first process and the at least one second process based on the fed forward and/or fed back measured effects of the first process and the at least one second process; and
means for affecting a second semiconductor device using the altered first process and/or the altered at least one second process, wherein the second semiconductor device has fewer die-to-die variations in critical dimensions of features than the first semiconductor device.

16. The process control system according to claim 15, wherein the second semiconductor device has fewer wafer-to-wafer or lot-to-lot variations in critical dimensions of features than the first semiconductor device.

17. The process control system according to claim 15, wherein the process control system is implementable continuously or periodically in a semiconductor device production facility.

18. The process control system according to claim 15, wherein the first process or the at least one second process comprise a lithography process, wherein the lithography process is performed in an optical lithography system, a non-optical lithography system, an x-ray lithography system, an interference lithography system, a short wavelength lithography system, a Scattering with Angular Limitation in Projection Electron-beam Lithography (SCALPEL) system, or an immersion lithography system.

19. A process control system, comprising:
a first process system for implementing a first procedure on a semiconductor device;
a first measurement system for measuring an effect of the first procedure of the first process system on a plurality of die of the semiconductor device;
a second process system for implementing a second procedure on the semiconductor device;
a second measurement system for measuring an effect of the second procedure of the second process system on the plurality of die of the semiconductor device; and
at least one feedback loop or at least one feed-forward loop coupled from an output to an input of the first process system, first measurement system, second process system, or the second measurement system, wherein the at least one feedback loop or the at least one feed-forward loop comprise: a first feedback loop coupling an output of the first measurement system to the first process system, a first feed-forward loop coupling an output of the first measurement system to the second process system, a second feed-forward loop coupling the output of the first measurement system to a comparator, a second feedback loop coupling an output of the second measurement system to the second process system, a third feed-forward loop coupling an output of the second measurement system to the comparator, or a third feedback loop coupling an output of the comparator to the first process system.

20. The process control system according to claim 19, wherein the first process system comprises a lithography system, and wherein the second process system comprises an etch system, wherein an exposure dose, focus level, or exposure tilt of the lithography system is adjusted in accordance with information from the first feedback loop, the second feedback loop, and the third feedback loop, and wherein an amount of trim of the etch system is adjusted in accordance with the information from the first feed-forward loop.

21. The process control system according to claim 20, wherein the first feedback loop provides correction of across-wafer systematic variations of the semiconductor device due to a lithography process of the lithography system by changing an individual exposure dose, exposure focus, or exposure tilt for each image field of the lithography system according to the first feedback loop information.

22. The process control system according to claim 20, wherein the first feed-forward loop provides correction of wafer-to-wafer variations of the semiconductor device in the lithography system or a lithography process of the lithography system by tuning etch process parameters of the etch system.

23. The process control system according to claim 20, wherein the third feedback loop provides correction of a reactive ion etch (RIE) chamber drift, an etch tool, and/or an etch process from the etch system-related systematic variations in across-wafer critical dimensions of the semiconductor device by changing a lithography process condition of the lithography system.

24. The process control system according to claim 20, wherein the second feedback loop provides etch tool drift and critical dimension distribution feedback to tune an etch process of the etch system using multi-zone chuck temperatures or dual injection gases.

25. The process control system according to claim 20, wherein the first feedback loop also includes an average dose feedback.

26. The process control system according to claim 19, wherein the first measurement system and the second measurement system comprise at least one scatterometer.
